(19) United States
(12) Patent Application Publication
(10) Pub. No.: US 2020/0311188 A1
(43) Pub. Date: Oct. 1, 2020

(54) DOCUMENT MANAGEMENT APPARATUS AND NON-TRANSITORY COMPUTER READABLE MEDIUM STORING PROGRAM

(71) Applicant: FUJI XEROX CO., LTD., Tokyo (JP)

(72) Inventor: Yuji KAZAMA, Kanagawa (JP)

(73) Assignee: FUJI XEROX CO., LTD., Tokyo (JP)

(21) Appl. No.: 16/507,007

(22) Filed: Jul. 9, 2019

(30) Foreign Application Priority Data
Mar. 25, 2019 (JP) 2019-055947

(51) Int. Cl. G06F 17/22

(52) U.S. Cl. CPC G06F 17/2288

(57) ABSTRACT

A document management apparatus includes a holding unit that holds information indicating a content of each of plural elements forming a first document; and a notification unit that notifies a participant of a second document related to the first document of information regarding a changed element of the first document in a case where at least one of the plural elements is changed.

### CROSS-REFERENCE TO RELATED APPLICATIONS

This application is based on and claims priority under 35 USC 119 from Japanese Patent Application No. 2019-055947 filed Mar. 25, 2019.

### BACKGROUND

### (i) Technical Field

The present invention relates to a document management apparatus and a non-transitory computer readable medium storing a program.

### (ii) Related Art

There are many documents related to each other in the world. In a case where one of documents related to each other is changed, some of the remaining documents may be required to be changed due to the change of the one document. There is a structure in which, in a case where a certain document is changed, a participant (for example, an author) of a document related to the document is informed of the change, and a necessary countermeasure such as changing of the related document is prompted.

For example, JP2000-155731A (JP3890785B) discloses a document update notifying device which determines whether or not there is a change of document data of a home page or the like, automatically adds information indicating that there is the change to a document related to the changed document in a case where there is the change, and sends a notification of the change to a user who can access the document, via a communication line.

### SUMMARY

There is a method in which, in a case where a first document is changed, a participant of a second document related to the first document is just notified that the first document is changed. In this method, the participant is required to check the entire first document in order to determine whether or not the change is required to be reflected in the second document.

Aspects of non-limiting embodiments of the present disclosure relate to a document management apparatus and a non-transitory computer readable medium storing a program capable of reducing time and effort for a participant to determine whether or not a change is required to be reflected in a second document compared with a method in which the participant of the second document related to a first document is just notified that the first document is changed.

Aspects of certain non-limiting embodiments of the present disclosure overcome the above disadvantages and/or other disadvantages not described above. However, aspects of the non-limiting embodiments are not required to overcome the disadvantages described above, and aspects of the non-limiting embodiments of the present disclosure may not overcome any of the disadvantages described above.

According to an aspect of the present disclosure, there is provided a document management apparatus including a holding unit that holds information indicating a content of each of a plurality of elements forming a first document; and a notification unit that notifies a participant of a second document related to the first document of information regarding a changed element of the first document in a case where at least one of the plurality of elements is changed.

### BRIEF DESCRIPTION OF THE DRAWINGS

Exemplary embodiment(s) of the present invention will be described in detail based on the following figures, wherein:

FIG. 1 is a diagram for explaining an example of a scene to which a structure of the present exemplary embodiment is applied;

FIG. 2 is a diagram illustrating a functional configuration of a document management apparatus;

FIG. 3 is a diagram for explaining an element included in a document and a case where a hash value is generated from a content of the element;

FIG. 4 is a diagram illustrating a data content stored in a document information database (DB);

FIG. 5 is a diagram for explaining that a hash value of an element is changed in a case where a content of the element in a document is changed;

FIG. 6 is a diagram illustrating an example in which an element is added to a document;

FIG. 7 is a diagram illustrating a data content stored in a relatedness DB;

FIG. 8 is a diagram illustrating an example of a screen on which a notification sent to a participant is displayed;

FIG. 9 is a diagram illustrating a state in which elements such as a graphic object and a text object are disposed in a document, and data of each of the elements stored in the document information DB;

FIG. 10 is a diagram illustrating an example in which a position of an element in a document is changed;

FIG. 11 is a diagram illustrating a data content in the document information DB in an example in which a notification of the element of which a position is changed is sent;

FIG. 12 is a diagram illustrating a screen for sending a notification of the element of which the position is changed to a participant; and

FIG. 13 is a diagram illustrating an example in which a relevance is stored in the relatedness DB.

### DETAILED DESCRIPTION

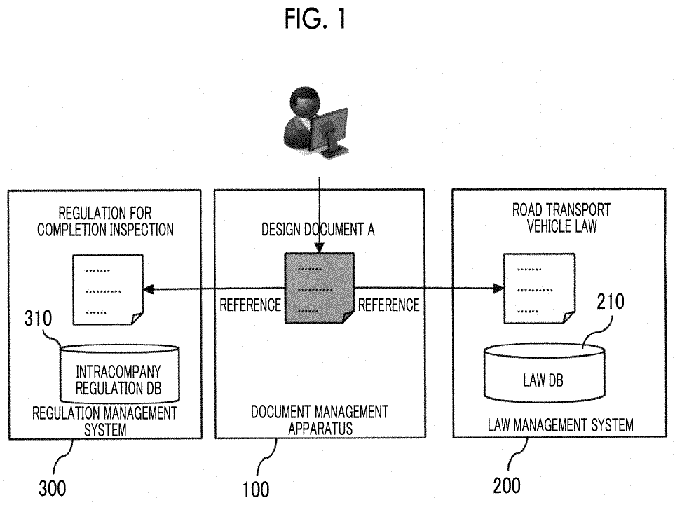

With reference to FIG. 1, a description will be made of an example of a scene to which a structure of the present exemplary embodiment is applied.

In the example illustrated in FIG. 1, a user in a certain company creates a design document A, registers the design document A of a certain product in a document management apparatus 100, and maintains the design document A. The product is required to be designed to satisfy various laws or various intracompany regulations, and thus the design document A is also created by referring to other documents such as the laws or the intracompany regulations. For example, the design document A is created by referring to the Road Transport Vehicle Law and the Regulation for Completion Inspection. A document referred to by the design document A may be present on an intracompany network of the company, and may be present outside (for example, on the Internet) of the company. For example, the Road Transport Vehicle Law is preserved in a law database (DB) 210 of a law management system 200 which is operated by a public institution, and is thus present on the Internet. The Regulation for Completion Inspection is an intracompany regulation of the company, and is preserved in an intracompany regulation DB 310 of a regulation management system 300 on the intra-company network. Each law in the law DB 210 and each regulation in the intracompany regulation DB 310 are updated at any time in tracking of revision. The law DB 210 or the intracompany regulation DB 310 is an example of a document storage location.

In a case where the Road Transport Vehicle Law and the loading completion information are revised, a content of the design document A may be required to be updated, but cannot be said to be necessarily updated. For example, in a case where a revised portion of a law or the like is different from a portion on which the content of the design document A is based, the content of the design document A is not required to be updated. In a case where a person in charge of management of the design document A only knows that a law referred to by the design document A is revised, the person in charge of management is required to carefully examine a content of the revised law or the like and thus to specify a revised portion, and to consider whether or not the content of the design document A is changed according to the revised portion. The system of the present exemplary embodiment provides information regarding a changed portion of a document such as a law, and thus supports work of a participant of a document such as a person in charge of management of the design document A determining whether or not the document is required to be changed according to the change of the related document of the document.

Here, the “document” is data having any data format, and the data format is not particularly limited. For example, the document may be data having a text data format, may be image data having various image data formats, may be moving image data, and may be data having a structured document format such as a Hypertext Markup language (HTML) format or an eXtensible Markup Language (XML) format.

In the present specification, a “participant” in a document is an individual or an organization involved in maintenance of a content of the document. For example, the participant may be a person in charge of maintenance of the content of the document, and may be a person playing a role to prompt the person in charge to execute maintenance. The “content” of the document is information which is viewable by a viewer in a case where the document is displayed.

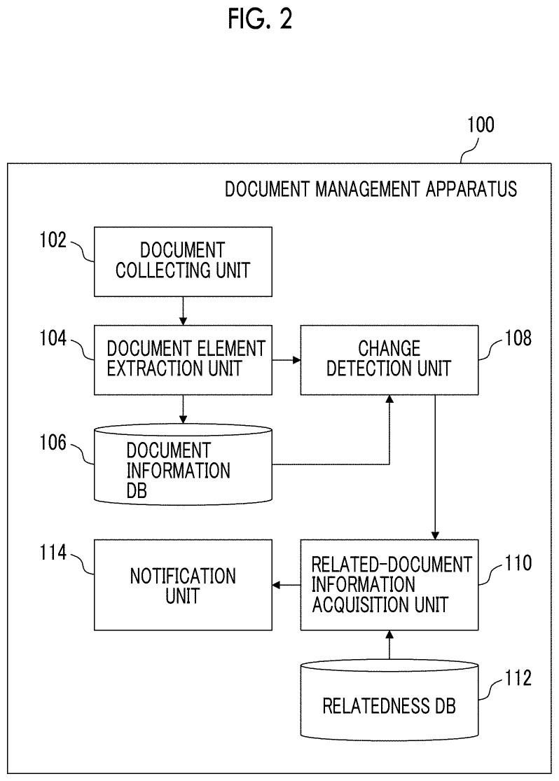

FIG. 2 illustrates a configuration of the document management apparatus 100 of the present exemplary embodiment. The document management apparatus 100 includes a document collecting unit 102, a document element extraction unit 104, a document information DB 106, a change detection unit 108, a related document information acquisition unit 110, a relatedness DB 112, and a notification unit 114.

The document collecting unit 102 collects, that is, acquires documents from a document DB group. The document collecting unit 102 is an example of an acquisition unit acquiring a document from a storage location thereof (that is, any one of the document DBs). A document DB which is a collecting destination may be present in the document management apparatus 100, may be present on the same intracompany network (for example, a local area network or an intranet) as the document management apparatus 100, and may be present on the Internet. The document collecting unit 102, such as a crawler, circulates the respective document DBs periodically or according to a circulation rule which is internally set, and collects a document group in the document DBs. In other words, the document collecting unit 102 repeatedly acquires respective documents at intervals. A document DB which is a collecting destination may be set in the document collecting unit 102 in advance, and may be found through retrieval based on information in a document (for example, a link buried in the document) collected by the document collecting unit 102. A collecting target document maybe designated in the document collecting unit 102 in advance instead of setting all documents in the document DBs as collecting targets. This designation may be performed by, for example, registering information (for example, a Uniform Resource Locator (URL)) for specifying a collecting target document in the document collecting unit 102.

The document element extraction unit 104 extracts an element included in a document collected by the document collecting unit 102. In other words, a collecting target document is formed of a plurality of elements, and thus the document element extraction unit 104 extracts each element included in the document. It may be said that the document element extraction unit 104 divides a document into the elements in the element unit.

For example, a law or a regulation has a hierarchical logical structure such as a chapter, an article, a paragraph, and an item. The document element extraction unit 104 extracts each element in a law according to a predetermined (that is, preset) rule such as an element (for example, an article) in a specific level among the elements, or an element in the lowest level (for example, in a case of there being an item, the item, and, in a case of an article not including an item, the article) . Since general documents other than laws often have a hierarchical structure such as a chapter, a clause, and a paragraph, the document element extraction unit 104 extracts an element defined by a predetermined rule in the hierarchical structure. A document such as an HTML document which is explicitly structured may be handled in the same manner. There is a document in which a hierarchical structure is not present among elements but a paragraph as each included element is clear (for example, a document not including a chapter or a clause but including a plurality of paragraphs), and the document element extraction unit 104 may extract an element from such a document. In a case where a document is formed of a plurality of pages, there may be an example in which each page is an element of the document.

The document information DB 106 is a database storing information indicating a content of each element extracted from a document by the document element extraction unit 104. The document information DB 106 is an example of a holding unit holding information indicating a content of each element forming a document.

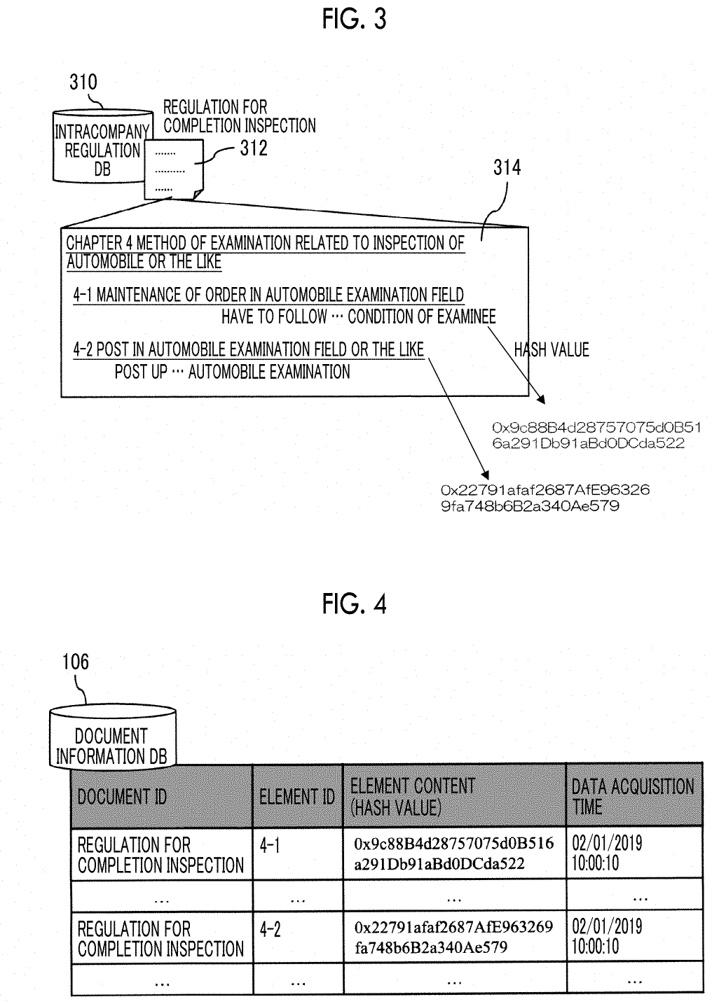

Here, with reference to FIGS. 3 and 4, a description will be made of a process (refer to FIG. 3) performed by the document element extraction unit 104 and a data content (refer to FIG. 4) stored in the document information DB 106.

As illustrated in FIG. 3, for example, it is assumed that a content 314 of Chapter 4 included in a document 312 having an identification name such as a regulation for completion inspection in the intracompany regulation DB 310 includes clauses represented by numbers of 4-1 and 4-2 as illustrated. In this case, the document element extraction unit 104 extracts, as elements, the subtitle of Chapter 4 “Chapter 4 Method of examination related to inspection of automobile”, Clause 4-1 (that is, a subtitle and a main text) , and Clause 4-2. A hash value of a content of each element (that is, text data including the element) is computed by using a predetermined hash algorithm.

As illustrated in FIG. 4, a single record (that is, data of a single row in the illustrated table) is stored for each element extracted by the document element extraction unit 104 in the document information DB 106. A record for each element includes respective items such as a document ID, an element ID, an element content, and a data acquisition time.

The document ID is identification information of a document including the element. In the illustrated example, for better understanding, the “regulation for completion inspection” which is the name of the document is illustrated as the document ID, but the document ID is not limited thereto.

The element ID is identification information of the element, and may be identification information for uniquely identifying the element in at least the document. In the illustrated example, a clause number is illustrated as the element ID.

The element content is information indicating a content of the element. In the illustrated example, a hash value of the content of the element is used as a value of the element content. A value stored in the item of the element content may be a value which is changed in response to a change of at least a content of the element. The hash value satisfies this requirement in practical use. Naturally, the content of the element (for example, text data of the element) also satisfies the requirement, and thus the content of the element may be stored as a value of the item of the element content in the document information DB 106.

In a case where a hash value of the element content is used as a value of the item of the element content, a data amount of the item is considerably reduced compared with a case where the element content is stored in the item. In a case where the document information DB 106 is located outside a user organization using the document management apparatus 100, a hash value is used as a value of the item, and thus the element content is prevented from leaking to the outside of the organization.

As other examples of a value stored in the item of the element content, there is compressed data obtained by compressing the element content or encrypted data obtained by encrypting the element content. In a case where the compressed data is used, a data amount of the item is reduced compared with a case where the element content is stored in the item.

The data acquisition time is a time point at which the document collecting unit 102 collects the document including the element.

A description of FIG. 2 will be continued. In a case where the document collecting unit 102 collects a document, the change detection unit 108 detects that a content of an element of the document is changed from a content of the element stored in the document information DB 106. In this detection process, the change detection unit 108 obtains a value (for example, a hash value) indicating a content of an element for each element of the collected document, and specifies a record including a combination of a document ID of the document and an element ID of the element from the document information DB 106. It is determined whether or not a value of an element content in the specified record is different from a value indicating a content of the element of the collected document. In a case where both of the values are the same as each other, it is determined that the content of the element is not changed from a time point at which information of the document is registered in the document information DB 106, and, in a case where both of the values are different from each other, it is determined that the content of the element is changed from the time point.

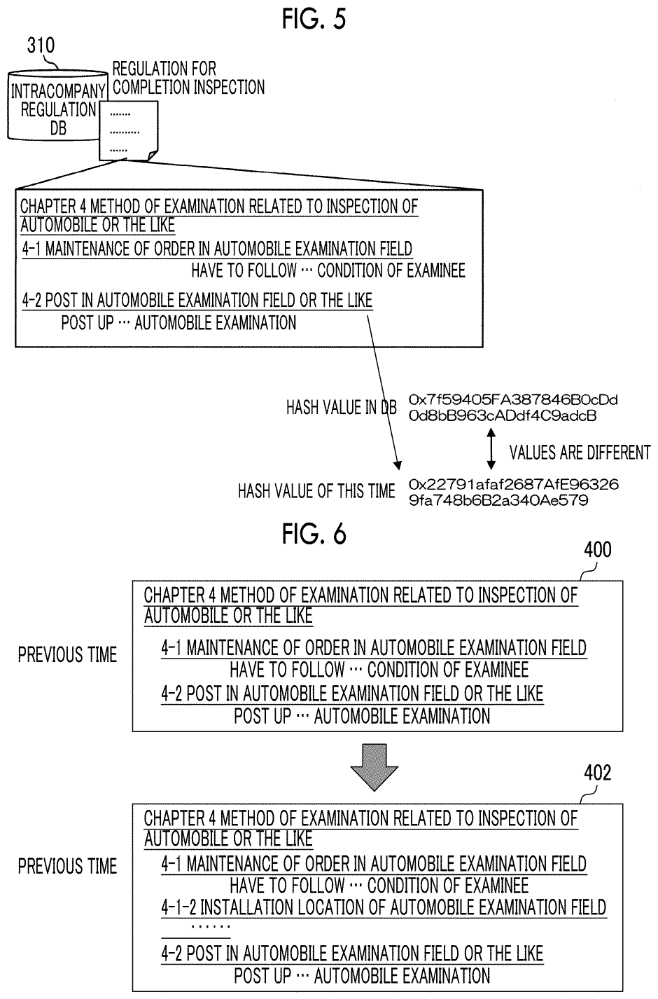

For example, in an example illustrated in FIG. 5, the change detection unit 108 obtains a hash value based on a content of the element “4-2” of the document “regulation for completion inspection” collected this time from the intracompany regulation DB 310. The hash value obtained this time is compared with a hash value of the element “4-2” of the document “regulation for completion inspection” held in the document information DB 106 at that time. In the illustrated example, since both of the values are different from each other, the change detection unit 108 determines that the content of the element “4-2” of the document “regulation for completion inspection” is changed.

In the above-described way, the change detection unit 108 detects that the content of the element of the collected document is changed from the content recorded in the record in the document information DB 106, and delivers information indicating the detected element (that is, the element of which the content is changed) to the related document information acquisition unit 110 and the notification unit 114 in the subsequent stage. The information delivered at this time includes the document ID of the document, the element ID of the detected element, and information indicating that the content of the element is changed.

The change detection unit 108 compares an element group of the collected document with records of the respective elements of the document in the document information DB 106, and thus determines the presence or absence of an added element, a deleted element, or both of the elements. In a case where the same element (that is, an element having the same document ID and element ID) as an element extracted from the collected document is not present in the document information DB 106, the element is not present at a time point at which information the document is registered in the document information DB 106, and is determined as being an added element. In a case where the same element as an element of the document in the document information DB 106 is not present in the collected document, the element is determined as being a deleted element. In a case where there is an added element or a deleted element with respect to the collected document, the change detection unit 108 detects this as a change of the element. In a case where an added element is detected, the change detection unit 108 delivers a document ID of the document, an element ID of the element, and information indicating that the element is added to the related document information acquisition unit 110 and the notification unit 114 in the subsequent stage. Similarly, in a case where a deleted element is detected, the change detection unit 108 delivers a document ID of the document, an element ID of the element, and information indicating that the element is deleted to the related document information acquisition unit 110 and the notification unit 114 in the subsequent stage.

In an example illustrated in FIG. 6, it is assumed that a content of a document of when information of the document is registered in the document information DB 106 at a previous time is a content indicated by the reference numeral 400, and a content of the identical document collected this time is a content indicated by the reference numeral 402. In this case, the change detection unit 108 detects that an element “4-ibis” which is not present in the former is added to the latter.

As mentioned above, with respect to a single collected document, the change detection unit 108 delivers information regarding an element of which a content is changed, an added element, or a deleted element when viewed from the time of information registered in the document information DB 106, to the related document information acquisition unit 110 and the notification unit 114.

In a case where the change detection unit 108 does not detect any of an element of which a content is changed, an added element, or a deleted element from a collected document, information of the document is not delivered to the related document information acquisition unit 110 and the notification unit 114. In this case, the related document information acquisition unit 110 and the notification unit 114 do not perform any process.

In a case where the change detection unit 108 detects the presence or absence of a change of a content of each element in a document collected this time, the document information

DB 106 may update a record of each element of the document. In other words, a data acquisition time in the record of each element of the document is changed to a time point at which the document is collected this time, and, with respect to an element of which a content is changed, a value of an element content is changed to a changed value (that is, a value indicating a content of the element of the document collected this time). With respect to an added element, a record of the element is added to the document information DB 106. With respect to a deleted element, a record of the element is deleted from the document information DB 106. In a method in which, whenever a document is collected, information of the document in the document information DB 106 is updated, the change detection unit 108 compares an element group of a document collected this time with an element group of the identical document collected at a previous time, and thus detects a content change, addition, or deletion of an element for the document. The document information DB 106 functions as an update unit that updates records of an element group stored therein. Through the update, the document information DB 106 holds, with respect to each document, information indicating a content of each element of when the document is collected at a previous time. When the change detection unit 108 initially collects, that is, acquires the document this time after information regarding each element of the document in the document information DB 106 is updated, the change detection unit 108 compares an element group included in the acquired document with the information regarding the element group of the document in the document information DB 106, so as to detect a change of an element.

In a case where information indicating a change, addition, or deletion of an element for a certain document is received from the change detection unit 108, the related document information acquisition unit 110 retrieves and acquires information of a document related to the document from the relatedness DB 112.

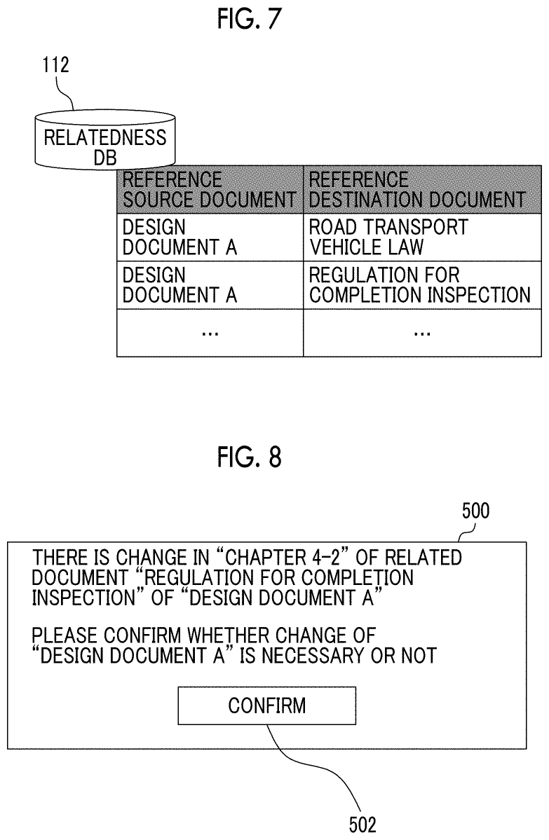

Information indicating the presence or absence of the relatedness between documents is registered in the relatedness DB 112. FIG. 7 illustrates a content of data held in the relatedness DB 112. In this example, information regarding a correspondence relationship between a reference source document and a reference destination document is registered in the relatedness DB 112. In the illustrated data, it is illustrated that the design document A which is a reference source document refers to two documents such as the Road Transport Vehicle Law and the Regulation for Completion Inspection. A method of building the relatedness DB 112 is not particularly limited. For example, a manager may manually register information regarding a correspondence relationship between reference source information and reference destination information in the relatedness DB 112. The relatedness DB 112 or another device may automatically extract a correspondence relationship between a reference source and a reference destination from information regarding a reference or link information therefor shown in a source field or a remarks field included in each document, and may register the correspondence relationship in the relatedness DB 112. A device providing a document editing function to a user may recognize, during editing of a document A, a document B (for example, a document displayed in a separate window during editing of the document A) referred to by the user, and may register the former as a reference source and the latter as a reference destination in the relatedness DB 112. In this case, a reference between a reference source and a reference destination may be registered in the relatedness DB 112 only in a case where a predetermined criterion such as the number of times of reference being equal to or more than a threshold value or a reference time being equal to or more than a threshold value is satisfied.

The related document information acquisition unit 110 acquires a document ID of a reference source document having a document ID included in information received from the change detection unit 108 as a value of the item “reference destination document”, from the relatedness DB 112. For example, in a case where a document of which an element is changed, added, or deleted is the “Regulation for Completion Inspection”, the related document information acquisition unit 110 acquires a document ID of the “design document A” which is a reference source document from the relatedness DB 112 illustrated in FIG. 7. The related document information acquisition unit 110 delivers the acquired document ID to the notification unit 114.

The notification unit 114 receives, from the change detection unit 108, a document ID of a document, information regarding an element ID of an element of which a content is changed or which is added or deleted in the document, and a change type (that is, any one of a content change, addition, or deletion) for each element ID. The notification unit 114 receives document IDs of one or more documents (that is, reference source documents) referring to the document from the related document information acquisition unit 110.

The notification unit 114 sends a notification of prompting checking to a participant of the reference source document referring to a document (referred to as a document A) of which an element is changed (at least one of a content change, addition, or deletion) by using the received information. The notification unit 114 is an example of a notification unit sending a notification of information regarding a changed element. Information required to send a notification to the participant maybe acquired from a database which is a collecting source of the reference source document. Such information may be, for example, a mail address of the participant, or a user ID of the participant in the document management apparatus 100. In the former case, the notification is sent to the participant as an electronic mail. In the latter case, the notification is displayed as notification information to the participant when the participant logs into the document management apparatus 100.

The notification sent to the participant from the notification unit 114 is a notification of prompting checking of whether or not a content of the reference source document is required to be changed according to the change of the element of the document A. The notification includes information (for example, the name of the document A) for specifying the document A, information for specifying an element (an element ID or the element, or a number of an article, a paragraph, or a clause) for each changed element in the document,

The notification may be data such as HTML indicating a screen content displayed on a terminal which is a notification destination.

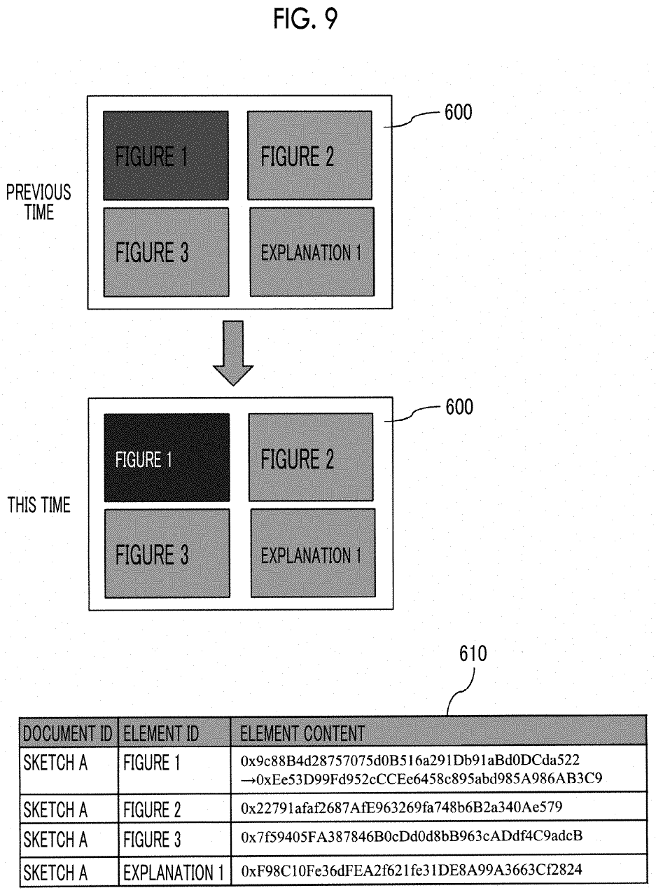

FIG. 8 illustrates a screen 500 for a notification displayed on a terminal which is a notification destination. This example is an example of a case where the change detection unit 108 detects that there is a content change in the element “Chapter 4, 4-2” of the document “Regulation for Completion Inspection”, and the related document information acquisition unit 110 detects the “design document A” as a reference source document referring to the document. A notification displayed on the screen 500 includes information regarding a checking target document (in this example, the “design document A”), a changed document (in this example, the “Regulation for Completion Inspection”), and a changed element (in this example, “Chapter 4, 4-2”), and a change type (in this example, “changed” =content change). The notification includes a message for prompting checking of whether or not the “design document A” which is a checking target document is required to be changed. A button 502 for instructing checking to be executed is provided on the screen 500. In a case where the participant viewing the screen 500 presses the button 502, the notification unit 114 provides, for example, a screen on which the latest (that is, changed) content of the element “Chapter 4, 4-2” of the changed document “Regulation for Completion Inspection” and a content of the “design document A” referring to the document are displayed, to a terminal of the participant. The participant judges whether or not the content of the “design document A” is required to be changed while checking the content of the element “Chapter 4, 4-2”. Not only the changed content of the element “Chapter 4, 4-2” but also the content before being changed (that is, an element content registered in the document information DB 106) may be displayed on the screen. Information regarding a difference between the contents before and after being changed may be displayed on the screen.

As mentioned above, the document management apparatus 100 of the present exemplary embodiment provides, to a participant of a reference source document referring to a changed document, not only information for specifying the document but also information for specifying a changed element in the document. Consequently, the participant can understand which element in the document is changed. The participant examines whether or not the reference source document is required to be changed while viewing a content of the changed element.

In a case where there are a plurality of elements are changed in a single collected document, the notification unit 114 notifies a participant of a reference source document of the document of pieces of information for specifying the plurality of changed elements. In a case where a notification of information regarding the plurality of changed elements is sent, the notification unit 114 may send a notification of an element of which a change type is “deletion” in a lower priority than an element of which a change type is “addition” or a “content change”. This is because the influence exerted to a reference source document of the document is higher in a case where an element of the document is “added” or has a “content change” than in a case where the element is “deleted”. For example, in a case where a provision is added to a law, it is necessary to immediately cope with the provision in the activities of individuals and companies. Particularly, in a case of an industry-related law, there are many provisions defining prohibition matters, and thus there is a high probability that the number of newly prohibited matters may be increased by an added provision, and it is highly necessary to make company documents related to the law to immediately cope with the added provision. In a case where a content of a provision is changed, there is a high probability that a content of a prohibition matter may be changed, and thus it is also necessary to immediately cope therewith. In contrast, in a case where a provision is deleted, a prohibition matter is generally rescinded. The degree of necessity for coping on a reference source document side is lower in a case where a prohibition matter is rescinded than in a case where a prohibition matter is added. Therefore, a notification of an element of which a change type is “deletion” is sent in a lower priority than an element of which a change type is “addition” or a “content change”.

Regarding attachment of a priority to a notification, a notification of information regarding an element having a higher priority in an identical document may be sent earlier. In a list of pieces of information regarding changed elements in an identical document, information regarding an element having a higher priority may be displayed at a more conspicuous position (that is, a side (for example, an upper side, or a left side in tab display)) which is displayed early in scroll display. Information regarding an element having a higher priority may be displayed in a more conspicuous display aspect (for example, large-sized or bold text).

A target document of the present exemplary embodiment is not limited to a text-based document such as the law described above. For example, as illustrated in FIG. 9, a document 600 (an identification name “sketch A”) including drawings may be a target. In this example, the document 600 includes respective graphic objects of FIGS. 1 to 3 and a text object having an identification name such as an “explanation 1” as elements. With respect to the document 600, data 610 held in the document information DB 106 includes, for example, a document ID, an element ID, a hash value of an element content, and a data acquisition time (not illustrated) for each element of FIGS. 1 to 3 and the “explanation 1”. In the illustrated example, a content of FIG. 1 is changed between when the document collecting unit 102 acquired the document 600 at a previous time and when the document collecting unit 102 acquires the document 600 this time. This change may be detected based on the fact that a hash value of the content of FIG. 1 acquired this time is different from a hash value of the content of FIG. 1 in the document information DB 106.

In the above example, a content change, addition, and deletion have been described as a change type of an element in a document. However, there is a document such as a sketch ora design drawing in which a change of a position (for example, a layout of an element group) of an element in a document has the great influence on the meaning of the element. For example, in a case of a design drawing, in a case where a position of a graphic object indicating a certain part is changed, a positional relationship between the part and another part is changed, and thus a content indicated by the drawing may be changed. With respect to such a type of document, the change detection unit 108 also detects a change of a position of an element.

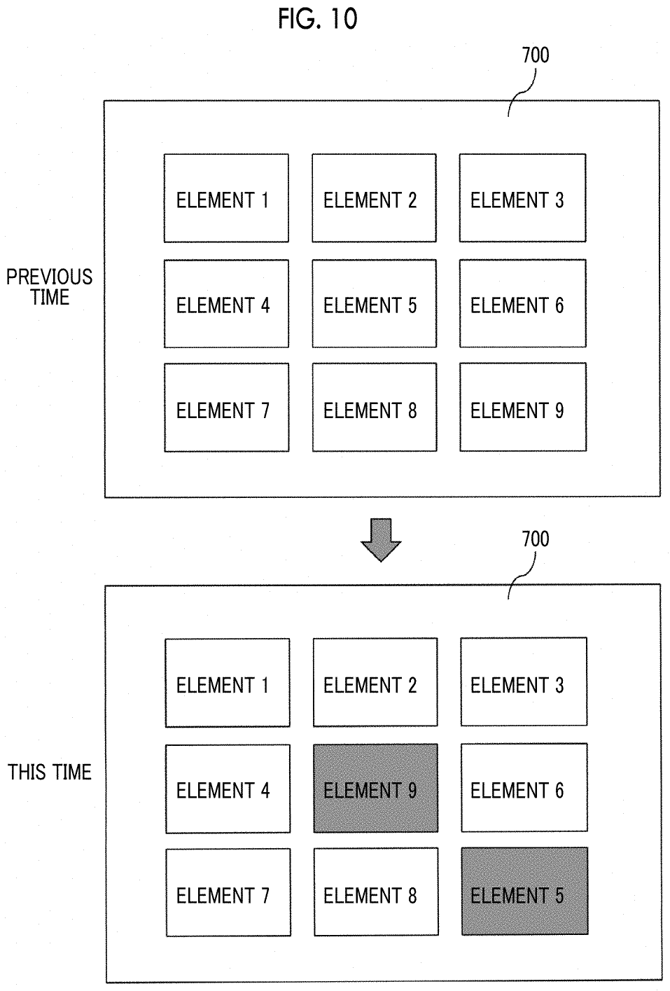

For example, as illustrated in FIG. 10, it is assumed that there is a document 700 in which nine elements such as elements 1 to 9 are disposed in a single page, and positions of the element 5 and the element 9 are replaced with each other between when the document 700 is acquired at a previous time and when the document 700 is acquired this time. The change detection unit 108 detects changes of the positions of the element 5 and the element 9.

In order to detect a change of a position of an element, the document element extraction unit 104 obtains a position of each element in a document, extracted from the collected document. The position of the element in the document is indicated by using a coordinate of the element in a page, for example, in a case where the document is an image of a single page. For example, a set of coordinates of two vertexes on a predetermined diagonal line of a circumscribed rectangle (for example, a circumscribed rectangle having sides parallel to the respective sides of the page) surrounding the element may be used as information indicating a position of the element. In a case where a document includes a plurality of pages, a combination of a number of a page including an element and information (for example, a set of coordinates defining a circumscribed rectangle) regarding a coordinate of the element in the page may be used as information indicating a position of the element.

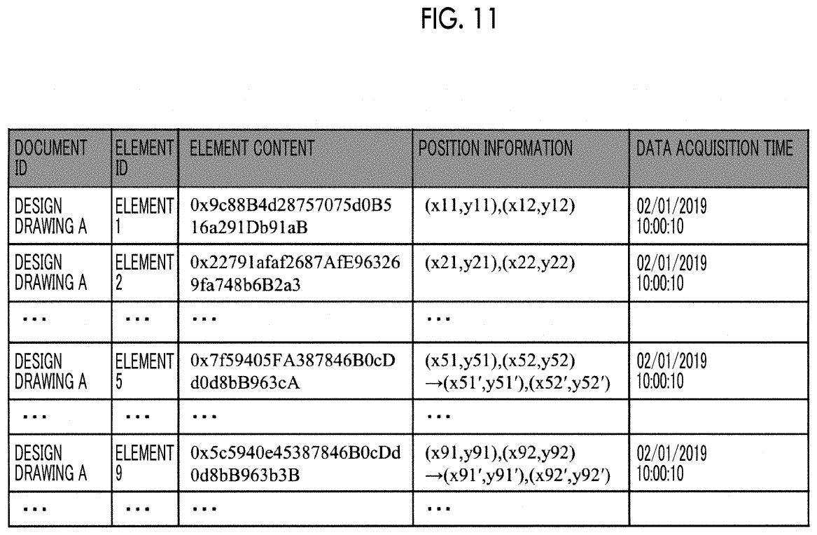

Position information indicating a position of each element extracted by the document element extraction unit 104 is stored in the document information DB 106. In this case, as illustrated in FIG. 11, the position information is registered in the document information DB 106 in addition to a document ID, an element ID, an element content, and a data acquisition time for each element. In this example, the position information of the element is a set of coordinates of two vertexes on a diagonal line of a circumscribed rectangle of the element.

The change detection unit 108 obtains a position in a document of each position of the document collected this time, and compares the position of each element with a position indicated by position information of each element of the document in the document information DB 106. Consequently, the change detection unit 108 detects an element of which a position is changed among elements of the document.

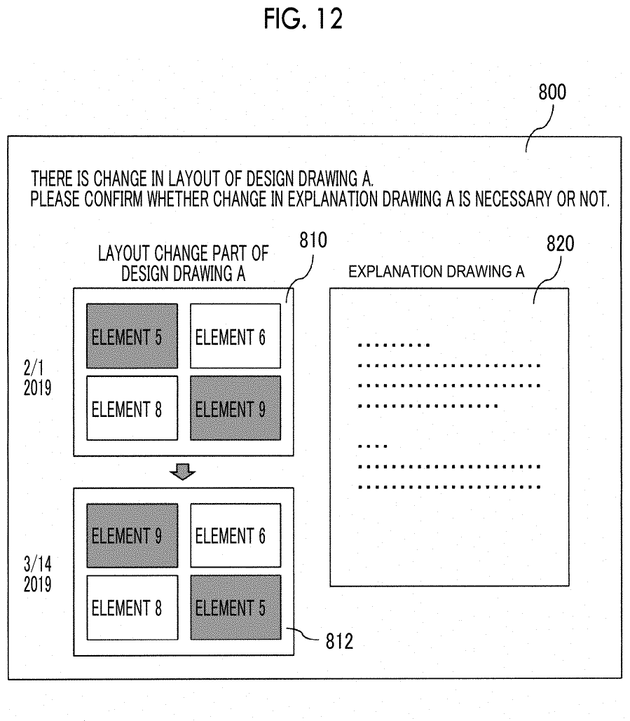

A notification sent from the notification unit 114 to a participant in a case where a position of the element is changed may include a screen indicating a change content of the position of the element. FIG. 12 illustrates an example of such a screen.

With respect to one or more elements of which positions are changed, an image 810 indicating positions before being changed and an image 812 indicating positions after being changed are disposed side by side on a notification screen 800 in FIG. 12 such that details can be understood. Here, the positions before being changed are positions stored in the document information DB 106, and the positions after being changed are positions in the document acquired this time. As mentioned above, a position of each element before being changed and a position of each element after being changed are displayed to be contrastable, and thus a participant can easily understand an element of which a position is changed and how the position is changed.

The images 810 and 812 are images in a range including all elements of which positions are changed in the document 700 illustrated in FIG. 10. In this example, the positions of the element 5 and the element 9 are replaced with each other, and thus the range (in the illustrated example, a range of 2×2 elements including the two elements) including the two elements is displayed. In a case of a content change, addition, or deletion of an element, a content of the element is displayed, and thus a participant can understand a content of the content change, the addition, or the deletion. In contrast, in a case where a position of an element is changed, and only a content of the element is displayed, a participant cannot understand a content of the change. Therefore, in this example, not only the elements of which the positions are changed but also the peripheral range of the elements in the document 700 is displayed on the images 810 and the 812. In this example, since positions of a plurality of elements are changed, not only all of the plurality of elements but also the peripheral range of the plurality of elements is displayed. Consequently, a participant understands an element group of which positions are changed in a list.

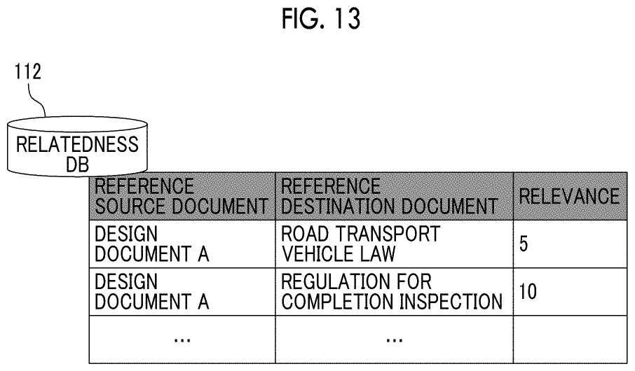

However, as illustrated in FIG. 13, a relevance between a reference source document and a reference destination document maybe registered in the relatedness DB 112. A value of the relevance may be input by a manager of the relatedness DB 112, or may be obtained according to a known technique of obtaining the degree of relatedness between documents. In a case where a certain document is changed, and there are a plurality of reference source documents referring to the document, the notification unit 114 may increase a priority of a notification of a reference source document having a higher relevance among the plurality of reference source documents. For example, a notification is sequentially sent to a participant of a reference source document having a higher relevance, or the degree of emphasis of a notification of information regarding a changed element may be increased for a participant of a reference source document having a higher relevance. In a case where a reference source document is changed in response to a notification from the notification unit 114, a database management program managing the relatedness DB 112 may update a value of the relevance of the reference source document to a greater value.

As mentioned above, the configuration and the process contents of the exemplary embodiment have been described. The exemplary embodiment described above is only an example, and various modifications may occur in the scope of the present invention.

The document management apparatus 100 described above may be implemented by causing a computer to execute a program realizing the functions of the element group configuring the document management apparatus. Here, the computer has, for example, a circuit configuration in which a microprocessor such as a CPU as hardware, memories (primary storage) such as a random access memory (RAM) and a read only memory (ROM), a controller controlling a stationary storage device such as a flash memory, a solid state drive (SSD), or a hard disk drive (HDD), various input/output (I/O) interfaces, and a network interface performing control for connection to a network such as a local area network are connected to each other via, for example, a bus. A program in which a process content of each function is described is preserved in the stationary storage device such as a flash memory so as to be installed in the computer. The program stored in the stationary storage device is read to the RAM, and is executed by the microprocessor such as a CPU, so that the function module group described above is realized.

As described above, the document management apparatus 100 may be configured on a single computer, and may be configured as a system including a plurality of computers which can perform communication with each other. In the latter case, for example, in an extreme example, the respective elements indicated by the reference numerals 102 to 114 may all be built on different computers.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A document management apparatus comprising:
a holding unit that holds information indicating a content of each of a plurality of elements forming a first document; and
a notification unit that notifies a participant of a second document related to the first document of information regarding a changed element of the first document in a case where at least one of the plurality of elements is changed.

2. The document management apparatus according to claim 1,
wherein a data amount of the information indicating the content of each of the plurality of elements forming the first document, held in the holding unit, is smaller than a data amount of the element in the first document.

3. The document management apparatus according to claim 2,
wherein the information indicating the content of each of the plurality of elements forming the first document, held in the holding unit, is a hash value of the content of each of the plurality of elements.

4. The document management apparatus according to claim 1, further comprising:
an acquisition unit that repeatedly acquires the first document from a storage location in which the first document is stored,
wherein, in a case where the information indicating the content of the element in the first document acquired this time by the acquisition unit is changed from the information indicating the content of the identical element in the first document acquired at a previous time by the acquisition unit, the notification unit sends a notification of information regarding the element.

5. The document management apparatus according to claim 2, further comprising:
an acquisition unit that repeatedly acquires the first document from a storage location in which the first document is stored,
wherein, in a case where the information indicating the content of the element in the first document acquired this time by the acquisition unit is changed from the information indicating the content of the identical element in the first document acquired at a previous time by the acquisition unit, the notification unit sends a notification of information regarding the element.

6. The document management apparatus according to claim 3, further comprising:
an acquisition unit that repeatedly acquires the first document from a storage location in which the first document is stored,
wherein, in a case where the information indicating the content of the element in the first document acquired this time by the acquisition unit is changed from the information indicating the content of the identical element in the first document acquired at a previous time by the acquisition unit, the notification unit sends a notification of information regarding the element.

7. The document management apparatus according to claim 4, further comprising:
an update unit that, every time the acquisition unit acquires the first document, updates the information held in the holding unit to information indicating a content of each of a plurality of elements forming the first document acquired at the time,
wherein, in a case where the information indicating the content of the element forming the first document which is initially acquired by the acquisition unit after the update unit performs update is changed from the information indicating the content of the element stored in the holding unit, the notification unit sends a notification of information regarding the element.

8. The document management apparatus according to claim 5, further comprising:
an update unit that, every time the acquisition unit acquires the first document, updates the information held in the holding unit to information indicating a content of each of a plurality of elements forming the first document acquired at the time,
wherein, in a case where the information indicating the content of the element forming the first document which is initially acquired by the acquisition unit after the update unit performs update is changed from the information indicating the content of the element stored in the holding unit, the notification unit sends a notification of information regarding the element.

9. The document management apparatus according to claim 6, further comprising:
an update unit that, every time the acquisition unit acquires the first document, updates the information held in the holding unit to information indicating a content of each of a plurality of elements forming the first document acquired at the time,
wherein, in a case where the information indicating the content of the element forming the first document which is initially acquired by the acquisition unit after the update unit performs update is changed from the information indicating the content of the element stored in the holding unit, the notification unit sends a notification of information regarding the element.

10. The document management apparatus according to claim 1,
wherein, in a case where a new element is added to the first document, or at least one of the plurality of elements of the first document is deleted, the notification unit notifies the participant of information regarding the added or deleted element.

11. The document management apparatus according to claim 2,
wherein, in a case where a new element is added to the first document, or at least one of the plurality of elements of the first document is deleted, the notification unit notifies the participant of information regarding the added or deleted element.

12. The document management apparatus according to claim 10,
wherein the notification unit sends a notification of information regarding the deleted element in a lower priority than information regarding the element of which a content is changed or information regarding the added element.

13. The document management apparatus according to claim 10, further comprising:
an acquisition unit that repeatedly acquires the first document from a storage location in which the first document is stored,
wherein, in a case where the first document acquired this time by the acquisition unit includes an element not included in a plurality of elements forming the first document acquired at a previous time by the acquisition unit, the notification unit notifies the participant of information regarding the element as information regarding the added element, and, in a case where the first document acquired this time by the acquisition unit does not include an element included in a plurality of elements forming the first document acquired at a previous time by the acquisition unit, the notification unit notifies the participant of information regarding the element as information regarding the deleted element.

14. The document management apparatus according to claim 13, further comprising:
an update unit that, every time the acquisition unit acquires the first document, updates the information held in the holding unit to information indicating a content of each of a plurality of elements forming the first document acquired at the time,
wherein, in a case where the first document which is initially acquired by the acquisition unit after the update unit performs update includes an element not included in a plurality of elements forming the first document stored in the holding unit, the notification unit notifies the participant of information regarding the element as information regarding the added element, and, in a case where the first document which is initially acquired by the acquisition unit after the update unit performs update does not include an element included in a plurality of elements forming the first document stored in the holding unit, the notification unit notifies the participant of information regarding the element as information regarding the deleted element.

15. The document management apparatus according to claim 1,
wherein the holding unit further holds position information indicating a position of each of the plurality of elements in the first document, and
wherein, in a case where a position of at least one of the plurality of elements is changed, the notification unit notifies the participant of information regarding the at least one element of which the position is changed.

16. The document management apparatus according to claim 15,
wherein the notification unit notifies the participant of a content of a range including the at least one element in the first document as the information regarding the at least one element of which the position is changed.

17. The document management apparatus according to claim 16,
wherein the notification unit notifies the participant of information indicating contrast between a content of the range before the position is changed and a content of the range after the position is changed as the information regarding the at least one element of which the position is changed.

18. The document management apparatus according to claim 15, further comprising:
an acquisition unit that repeatedly acquires the first document from a storage location in which the first document is stored,
wherein, in a case where a position of at least one of the plurality of elements is changed,
and a position of the element in the first document acquired this time by the acquisition unit is changed from a position of the identical element in the first document acquired at a previous time by the acquisition unit, the notification unit sends a notification of information regarding the element.

19. The document management apparatus according to claim 18, further comprising:
an update unit that, every time the acquisition unit acquires the first document, updates position information of each of a plurality of elements held in the holding unit to information indicating a position of each of a plurality of elements forming the first document acquired at the time,
wherein, in a case where a position of the element of the first document which is initially acquired by the acquisition unit after the update unit performs update is changed from a position indicated by the position information of the element stored in the holding unit, the notification unit sends a notification of information regarding the element.

20. A non-transitory computer readable medium storing a program causing a computer to function as:
a holding unit that holds information indicating a content of each of a plurality of elements forming a first document; and
a notification unit that notifies a participant of a second document related to the first document of information regarding a changed element of the first document in a case where at least one of the plurality of elements is changed.
